(19) United States
(12) Patent Application Publication
(10) Pub. No.: US 2010/0033564 A1
(43) Pub. Date: Feb. 11, 2010

(54) VEHICLE MONITORING SYSTEM

(75) Inventors: WEI-CHIN LEE, Tu-Cheng (TW); TA-HSAING CHAO, Tu-Cheng (TW); SHANG-YI LIN, Tu-Cheng (TW); PO-WEN CHAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/334,536

(22) Filed: Dec. 15, 2008

(30) Foreign Application Priority Data
Aug. 8, 2008 (CN) 200810303626.4

(51) Int. Cl. H04N 7/00; H04N 9/31

(52) U.S. Cl. 348/115; 348/744; 348/E07.001; 348/E09.025

(57) ABSTRACT

A monitoring system for a vehicle includes an image capture unit, a reflective film, and a projection unit. The vehicle includes a windshield. The image capture unit is configured for acquiring visual information of the vehicle. The reflective film is formed on a predetermined area of the windshield. The projection unit is configured for projecting the images onto the predetermined area.

### BACKGROUND

1. Technical Field

The disclosure relates to a monitoring system acquiring and displaying vehicle information.

2. Description of the Related Art

Traditional vehicle information display systems work well for their intended purposes. However, these display systems typically include a display panel installed in the vehicle instrument area, which can restrict the driver. Moreover, in-vehicle video displayers are normally installed behind the driver seat, and therefore are beyond drivers' sight.

Therefore, it is desirable to provide a vehicle monitoring system, which can overcome the described limitations.

### BRIEF DESCRIPTION OF THE DRAWINGS

FIG. 1 is a schematic view of a vehicle monitoring system according to an embodiment.

FIG. 2 is a schematic view illustrating a projection route of a projection unit of FIG. 1.

### DETAILED DESCRIPTION OF THE EMBODIMENT

An embodiment of a vehicle monitoring system is described in detail here with reference to the drawings.

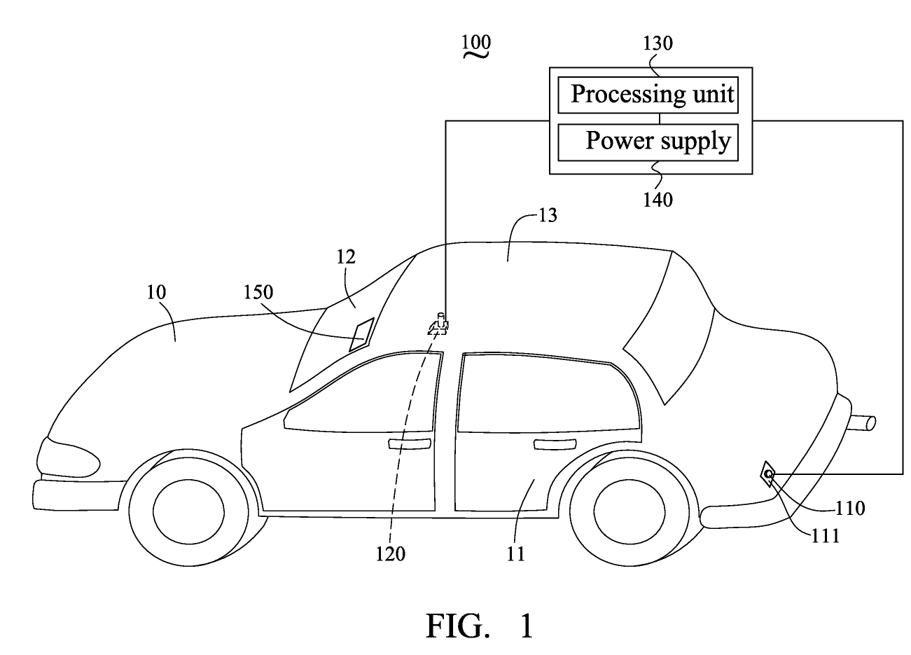

Referring to FIG. 1, a monitoring system 100 installed in a vehicle 10 includes an image capture unit 110, a projection unit 120, a processing unit 130, a power supply 140, and a projection area 150. The vehicle 10 includes a body 11, a windshield 12 assembled in the body 11, and a roof 13 adjacent to the windshield 12. The power supply 140 is electrically coupled to the image capture unit 110, the projection unit 120 and the processing unit 130 and configured for providing electrical power thereto.

The image capture unit 110 is installed at the rear of the body 11 for acquiring rearview information. While the image capture unit 110 is installed here at the rear of the vehicle 10, it can, alternatively, be installed in any position on the vehicle 10 for acquiring information corresponding thereto. The image capture unit 110 includes a camera with a wide angle lens, and a rotatable base 111 fixed to the body 11. The image capture unit 110 can be assembled in the rotatable base 111, providing capture of information around the vehicle 10. Furthermore, the image capture unit 110 also includes a waterproof cover (not shown).

The projection unit 120 is suspended from the roof 13 and can be adjusted to any orientation, providing projected display in any desired area. The projection unit 20 is a mini projector, but can alternatively be a digital light processing (DLP) projector, liquid crystal display (LCD) projector, or liquid crystal on silicon (LCOS) projector.

The processing unit 130 assembled to the vehicle 10 is electrically coupled to the image capture unit 110 and the projection unit 120. The processing unit 130 converts an image signal from the image capture unit 110 to a digital signal for transmission to the projection unit 120.

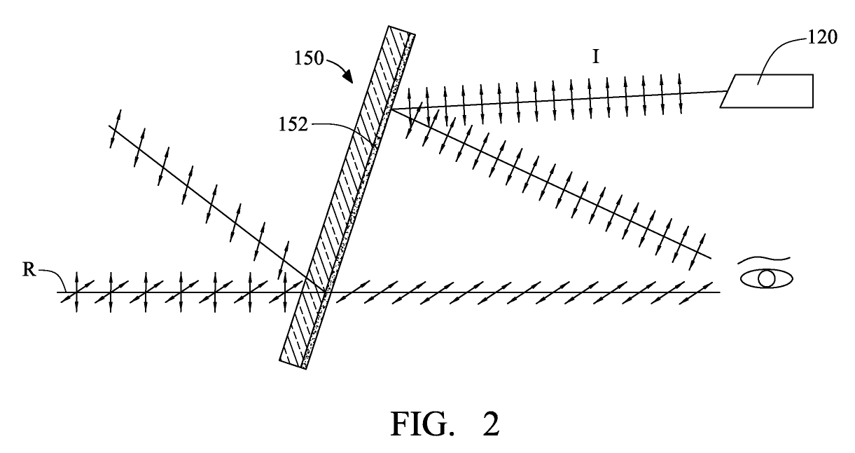

As shown in FIG. 2, the projection area 150 has a reflective film 152 disposed thereon, which can reflect S-polarized light of image light I projected by the projection unit 120, such that the captured image is viewable at the projection area 150. Furthermore, when light R is emitted from an external environment into the projection area 150, S-polarized light of the light R is reflected by the reflective film 152 and P-polarized light of the light R can pass through the reflective film 152 to be viewable without interfering with the driver's vision. In particular, when the projection area 150 is located within the driver's viewable area when operating the vehicle 10, rearview information is available without distraction.

In operation, when the power supply 140 is turned on, the image capture unit 110, the projection unit 120 and the processing unit 130 are activated, and the waterproof cover (not shown) opens to allow the image capture unit 110 to operate. The processing unit 130 converts the received image signal of the captured image to a digital signal. The projection unit 120 converts the digital signal to an image signal for projection as image light I onto the projection area 150. The image light I, being S-polarized light, is completely reflected onto projection area 150 by reflective film 152, providing a clear view of the captured image. Concurrently, light R, having both S-polarized light and P-polarized light, entering from the external environment, is filtered to allow only P-polarized light through the projection area 150, providing a clear front view through the windshield. Here, since the projection area 150 is established on the windshield 12, it is therefore able to provide a larger view area than otherwise available one in dashboard-area space.

It is to be noted that, in practice, the projection area 150 can be transparent, or semi-transparent, so long as the driver view is unobstructed thereby, while remaining well within the scope of the disclosure.

It will be understood that the above particular embodiments are described and shown in the drawings by way of illustration only. The principles and features of the disclosure may be employed in various and numerous embodiments thereof without departing from the scope of the invention as claimed. The above-described embodiments illustrate the scope of the invention but do not restrict the scope of the invention.

What is claimed is:

1. A vehicle monitoring system, applicable in a vehicle comprising a windshield, the monitoring system comprising:
an image capture unit configured for acquiring visual information;
a reflective film capable of being formed on a predetermined area of the windshield; and
a projection unit configured for projecting the visual information onto the reflective film.

2. The monitoring system of claim 1, wherein the image capture unit is configured to be fixed at the rear of the vehicle.

3. The monitoring system of claim 1, wherein the vehicle further comprises a roof, and the projection unit is further configured to be suspended therefrom.

4. The monitoring system of claim 1, wherein the image capture unit comprises a lens, and the lens is a fisheye lens.

5. The monitoring system of claim 1, wherein the projection unit is a digital light processing projector, a liquid crystal display projector, or a liquid crystal on silicon projector.

6. The monitoring system of claim 4, wherein the image capture unit further comprises a base configured to be fixed on the of the vehicle, and the fisheye lens is rotatable relative to the base.

7. The monitoring system of claim 6, wherein the image capture unit is capable of capturing a panoramic view of the vehicle area.

8. The monitoring system of claim 1, further comprising a processing unit electrically coupled to the image capture unit and the projection unit, the processing unit being capable of converting captured images into digital signals for the projection unit.

9. The monitoring system of claim 8, further comprising a power supply electrically coupled to the image capture unit, the projection unit and the processing unit, and providing electrical power thereto.

10. The monitoring system of claim 1, wherein the reflective film is transparent or semi-transparent to let the front view come through.

11. A projection system for acquiring and projecting visual information of a vehicle, the vehicle comprising a windshield, the projection system comprising:
an image capture unit configured for acquiring visual information as an image signal;
a processing unit converting the image signal to a digital signal;
a reflective film formed on a predetermined area of the windshield;
a projection unit receiving and projecting the digital signal onto the reflective film of the windshield; and
a power supply electrically coupled to the image capture unit, the processing unit, and the projection unit, and providing electrical power thereto.

12. The projection system of claim 11, wherein the image capture unit comprises a camera fixed at the rear of the vehicle.

13. The projection system of claim 11, wherein the image capture unit comprises a lens, and the fisheye lens is with a wide viewing angle.

14. The projection system of claim 11, wherein the projection unit is a digital light processing projector, liquid crystal display, or liquid crystal on silicon projector.

15. The projection system of claim 11, wherein the vehicle comprises a roof, from which the projection unit is suspended.

16. The projection system of claim 11, wherein the reflective film is transparent or semi-transparent to let the front view come through.
